(19) United States
(12) Patent Application Publication
(10) Pub. No.: US 2021/0171136 A1
(43) Pub. Date: Jun. 10, 2021

(54) DEVICE FOR MOVING TRAILERS

(71) Applicant: Dennis Kaiser, Waterford, MI (US)

(72) Inventor: Dennis Kaiser, Waterford, MI (US)

(21) Appl. No.: 16/706,815

(22) Filed: Dec. 8, 2019

(51) Int. Cl. B62D 59/04; B60K 7/00; B62D 5/06; G05D 1/00

(52) U.S. Cl. CPC B62D 59/04; B60K 7/0015; G05D 1/0016; B62D 5/064; B60K 7/0007

(57) ABSTRACT

A device for moving trailers (the device) enables anyone to easily maneuver and guide and park precisely in a specific location a trailer such as camper, utility, boat, horse or any other type of a tow behind a vehicle trailer without being attached to a vehicle. The device allows anyone to drive a parked trailer from its parked location to the towing vehicle with precise alignment to the ball hitch of the towing vehicle. The device is self-powered for the purpose of lifting and or lowering the trailer hitch on or off the hitch ball of the towing vehicle and a hydraulic pump and reservoir and a pair hydraulic motors for the forward and reverse movement and the left and right steering. The device is controlled with a wireless hand held remote through a Bluetooth operation system and or a phone application, which can be downloaded onto your smart phone.

### FIELD OF THE INVENTION

The present invention relates generally to devices for moving trailers, caravans and for maneuvering the trailers and the caravans.

### BACKGROUND OF THE INVENTION

Situations are frequently encountered when it is not possible to maneuver a trailer, caravan or the like by means of a towing vehicle because of limited space available for example in a yard or on a slipway. It is then necessary to manhandle the trailer, caravan or the like and this often involves hard physical effort, even when a jockey wheel is fitted, and may in some circumstances not be possible unless assistance is at hand.

Prior art is replete with various devices. One prior art reference teaches a device for moving trailers, caravans and the like comprises a frame on which a pair of wheels are mounted on an axle which extends through plates at one end of the frame. An electric motor is mounted on a drive shaft and is arranged to drive the axle via a series of pulleys and associated belts. A further single wheel is rotatably mounted in a U-shaped frame or caster which is rotatably mounted in a bearing provided on a plate which is secured to the other end of the frame.

Alluding to the above, levering or steering arm or handle is also secured to this end of the frame and a ball coupling for engaging the towing eye of a trailer, caravan or the like is mounted on an L-shaped bar which is secured to gusset plates provided at the said one end of the frame. The electric motor may be an electric drill or a fixed motor driven from the main or a battery.

This prior art reference fails to teach a device that will allow the individual the ability to guide the movement of their trailer with unprecedented control and accuracy and zero radius turning ability and to allow a user to steer and guide the parking of any trailer without being connected to a car, truck or other motorized vehicle.

The present invention aims to solve this problem by simple and convenient means.

### SUMMARY OF THE INVENTION

A mobility device (the device) of the present invention is used for moving trailers and for maneuvering the trailers between various locations and obstacles such as, for example, bushes and trees. The device includes a lower end assembly and an upper end assembly or a control unit. The lower end assembly and the upper end assembly share a common axis. The lower end assembly and the upper end assembly are movable relative to one another in vertical direction along the common axis A. In other words, when the lower end assembly is positioned on the ground, the upper unit assembly is moved to and from the lower unit assembly. The lower unit assembly is rotatable about the axis A and around the upper end assembly.

The device allows anyone to drive a parked trailer from its parked location to the towing vehicle with precise alignment to the ball hitch of the towing vehicle. The device is self-powered for the purpose of lifting and or lowering the trailer hitch on or off the hitch ball of the towing vehicle and a hydraulic pump and reservoir and a pair hydraulic motors for the forward and reverse movement and the left and right steering. The device is controlled with a wireless hand held remote device through a Bluetooth operation system and or a phone application, which can be downloaded onto your smart phone.

The device of the present invention designed to be a permanent part of the trailer and take the place of the existing jack that is mounted on the trailer. This lower unit re-tracks up into the trailer frame allowing for enough clearance between the ground and the bottom of the wheels on the lower unit. This allows the trail to be connected to the vehicle and be driven across country to the users destination. Once the driver has reached there destination and the trailer is ready to be parked, the driver will disconnect all attached items which tie the trailer to the vehicle.

Alluding to the above, this is done by unlatching release lever for the vehicle ball, safety chains and electrical connection at the trailer which tie the vehicle to the trailer. The driver will then use the device to take over parking responsibility. First the driver presses the PWR button on the remote. Once power has been turned on to the device it is ready to use. Pressing the UP button will lift the trailer hitch off the truck trailer hitch ball. Next the trailer must be moved away from the vehicle by pressing the REV button on the remote. This will back the trailer away from the vehicle. Before driving the trailer to it final destination the device must lower the trailer to a level position. This is done by pressing the DWN button and watching the level usually permanently attach to a trailer for leveling purposes. Once the driver has the trailer level the trailer is now ready to park using the remote controller.

An advantage of the present invention is to provide an improved device for moving trailers guide and park precisely in a specific location a trailer such as camper, utility, boat, horse or any other type of a tow behind a vehicle trailer without being attached to a vehicle.

Another advantage of the present invention is to provide the improved device for moving trailers guide to allow anyone to drive a parked trailer from its parked location to the towing vehicle with precise alignment to the ball hitch of the towing vehicle.

Still another advantage of the present invention is to provide an improved device for moving trailers, which is self-powered, for the purpose of lifting and or lowering the trailer hitch on or off the hitch ball of the towing vehicle and a hydraulic pump and reservoir and a pair hydraulic motors for the forward and reverse movement and the left and right steering.

Still another advantage of the present invention is to provide the improved device for moving trailers, which is controlled with a wireless hand held remote through a Bluetooth operation system and or a phone application, which can be downloaded onto your smart phone.

Still another advantage of the present invention is to provide the improved device for moving trailers to allow an individual the ability to guide the movement of their trailer with unprecedented control and accuracy and zero radius turning ability.

Still another advantage of the present invention is to provide the improved device for moving trailers to allow a simple and wireless control which allows a user to steer and guide the parking of any trailer without being connected to a car, truck or other motorized vehicle.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a trailer with a device of the present invention connected to the trailer;

FIG. 2 is a bottom view of the device;

FIG. 3 is a side view of the device

FIG. 4 is a top schematic view of the trailer with the device connected to the trailer wherein various maneuvering positions of the trailer are shown, as the device is controlled with a wireless hand held remote through a Bluetooth operation system, and/or a phone application, which can be downloaded onto a smart phone.

FIG. 5 is a perspective view of the screen of the wireless hand held remote.

FIG. 6 is a side and cross-sectional view of a lower unit of the lower end assembly of the device;

FIG. 7 is a front view of the lower end assembly of the device;

FIG. 8 is a perspective view of the lower end assembly;

FIG. 9 is a top and cross-sectional view of the lower end assembly;

FIG. 10 is a rear cross-sectional view of the lower end assembly;

FIG. 11 is a top view of an upper control unit;

FIG. 12 is a perspective unit of the upper control unit; and

FIG. 13 is a side view of the upper control unit.

FIG. 14 shows a prior art device, used only to lower and upper the trailer to level the trailer relative the ground or surface and the vehicle ball of the vehicle; and

FIG. 15 shows the device of the present invention designed to be a permanent part of the trailer and take the place of the existing jack that is mounted on the trailer.

### DETAILED DESCRIPTION OF THE INVENTION

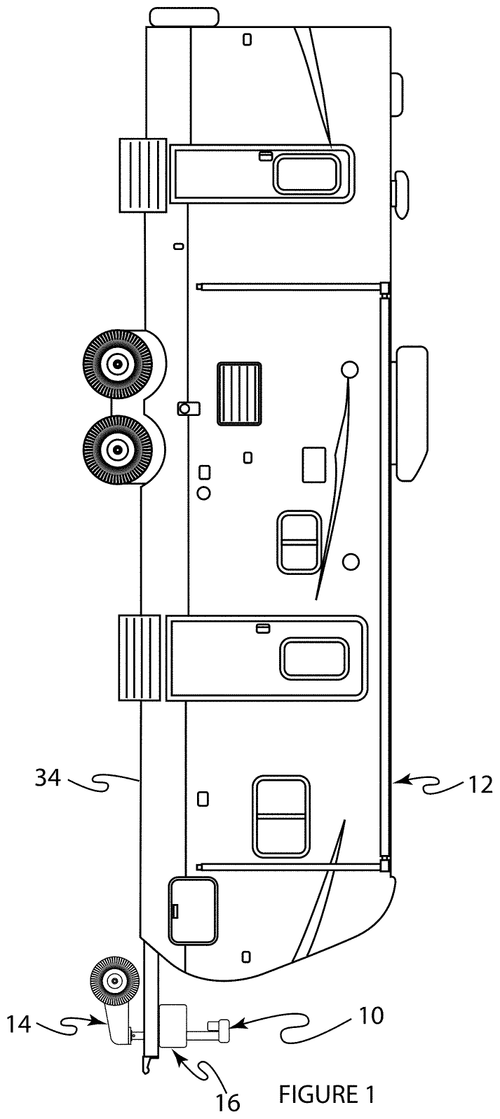

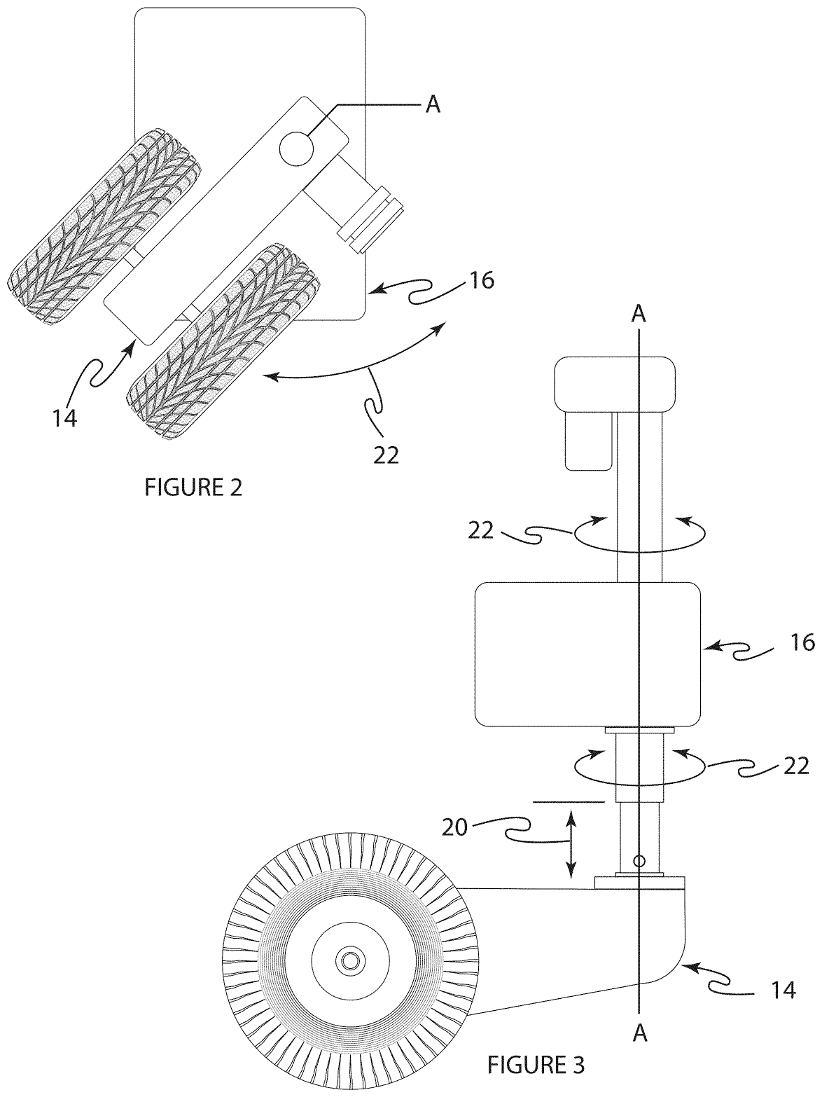

Referring to FIGS. 1 through 4, a mobility device (the device) of the present invention, is generally shown at 10. The device 10 is used for moving trailers 12 and for maneuvering the trailers 12 between various locations and obstacles such as, for example, bushes and trees, generally indicated at B. The device 10 includes a lower end assembly generally indicated at 14 and an upper end assembly or a control unit, generally indicated at 16 in FIGS. 2 and 3. The lower end assembly 14 and the upper end assembly 16 share a common axis A. The lower end assembly 14 and the upper end assembly 16 are movable relative to one another in vertical direction as shown at 20 along the common axis A. In other words, when the lower end assembly 14 is positioned on the ground, the upper unit assembly 16 is moved to and from the lower unit assembly 14 as shown at 20. The lower unit assembly 14 is rotatable about the axis A and around the upper end assembly 16 as shown at 22.

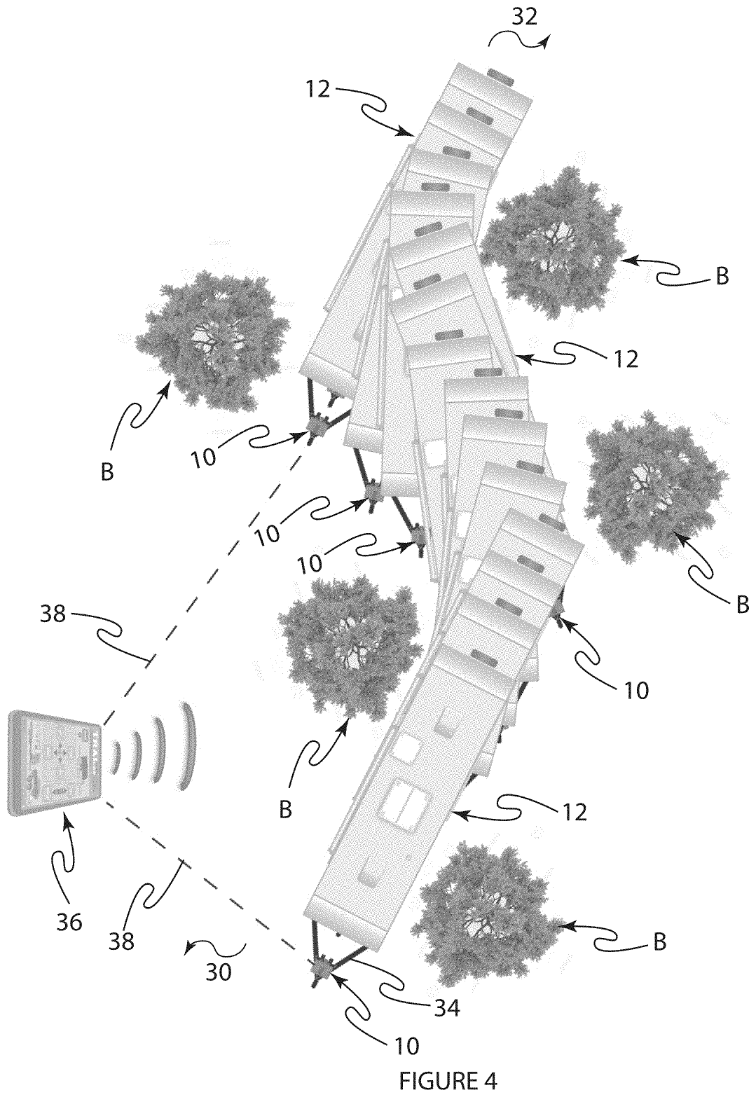

The device 10 allows anyone to drive the parked trailer 12 from its parked location 30 to a desired location 32 as shown in FIG. 4. The device 10 is self-powered for the purpose of lifting and or lowering the trailer hitch 34 and a hydraulic pump and reservoir and a pair hydraulic motors for the forward and reverse movement and the left and right steering of the device 10. The device 10 is controlled with a wireless hand held remote device 36 through a Bluetooth operation system and or a phone application, which can be downloaded onto a smart phone.

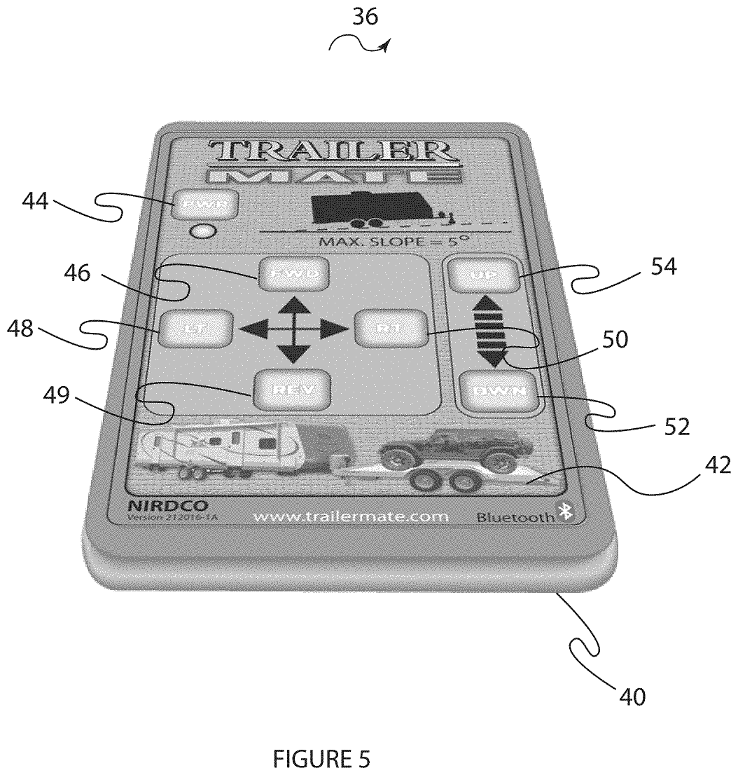

As best shown in FIG. 5, wireless hand held remote device 36 includes a housing 40, a touchtone screen 42, a “power” button 42, a “move forward” button 46, a “left turn” button 48, a “move back” button 49, a “right turn” button 50, and “up movement” and “down movement” buttons 52 and 54. Those skilled in the art will appreciate that other modifications of the options and additional options may be used without limiting the scope of the present invention.

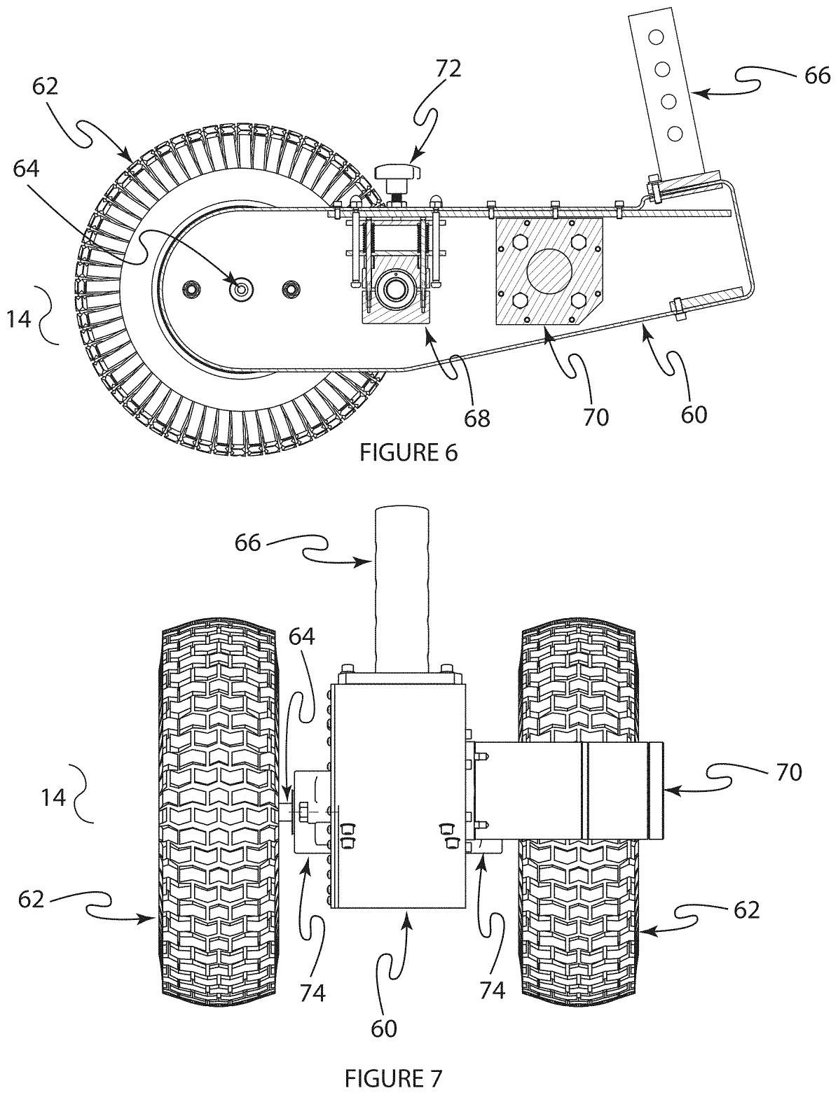

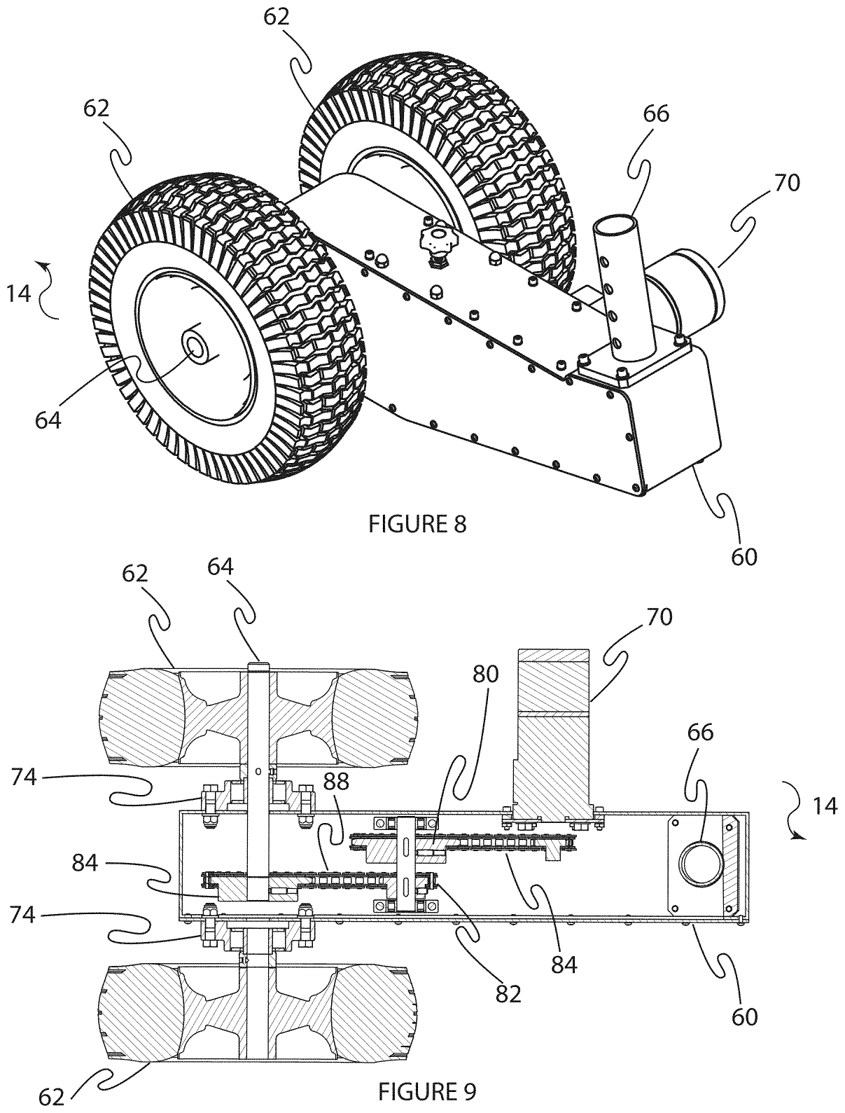

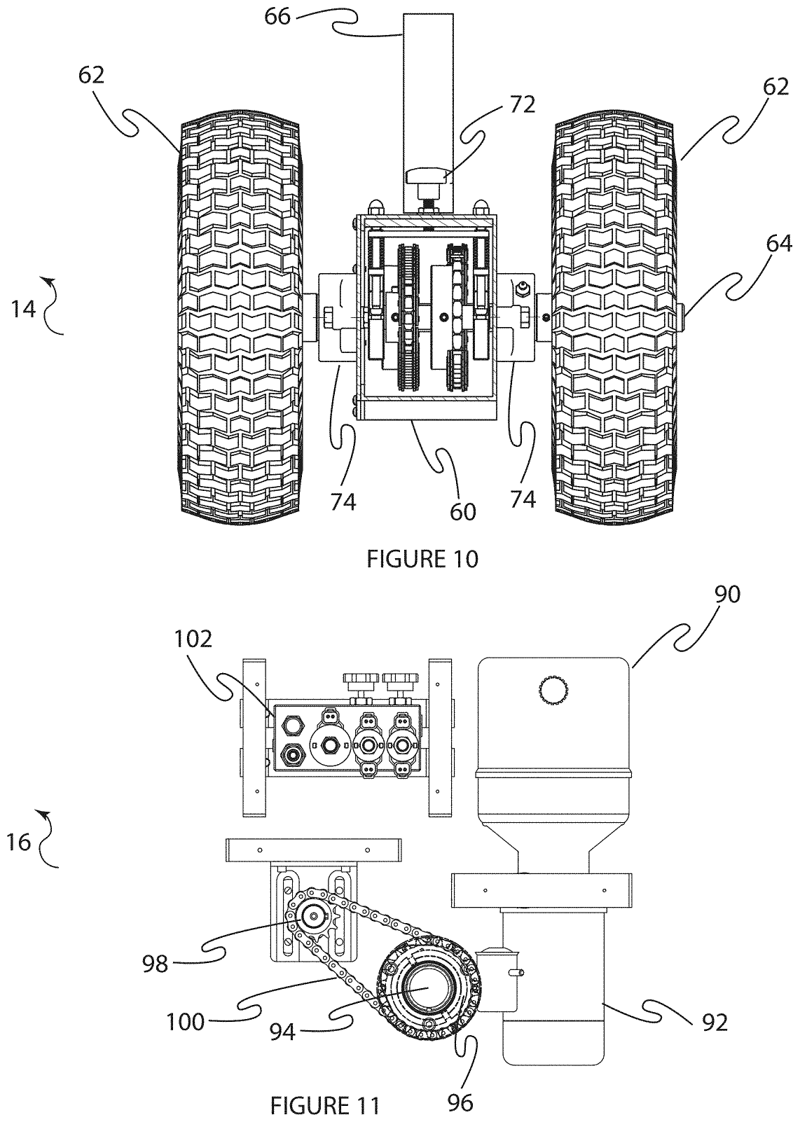

Referring to FIGS. 6 through 10, the lower unit assembly 14 will now be discussed. As best shown in FIGS. 6 through 8, the lower unit assembly 14 includes a housing 60, to house forward and reverse drive assembly, is formed from metal or any other rigid material without limiting the scope of the present invention. A pair of wheels 62 are connected to and extend from the housing 60. The wheels 62 are rotatable about drive axle 64 defining a wheel axis.

Alluding to the above, an extender element or extension rod 66 is connected to the housing 60 and is used to adjustably connect the lower unit assembly 14 with the upper unit assembly 16. A drive chain tensioner device 68 is positioned in the housing 60 along with a hydraulic motor mounting plate 70. A drive chain tension knob 72 is mechanically connected to the drive chain tensioner device 68 to adjust tension of the drive chain as required and during installation. A pair of drive wheel axle bearings 74 are mechanically connected to the drive wheel axle 64.

Referring now to FIG. 9, a top and cross-sectional view of the lower end assembly 14 is shown. The forward/reverse hydraulic motor 70 is mechanically connected to a hydraulic motor intermediate drive gear device 80, which in turn is connected to a drive wheel intermediate gear device 82. A hydraulic motor drive chain 84 is engaged about the drive wheel intermediate gear device 80 to translate rotational motion to the drive wheel intermediate gear device 82. The drive wheel intermediate gear device 82, through a drive wheel drive chain 88, translates the rotational motion to a drive wheel drive gear 84. The drive wheel gear 84 in turn rotates the drive wheel axle 64 in order to move the wheels 64 in forward and reverse directions.

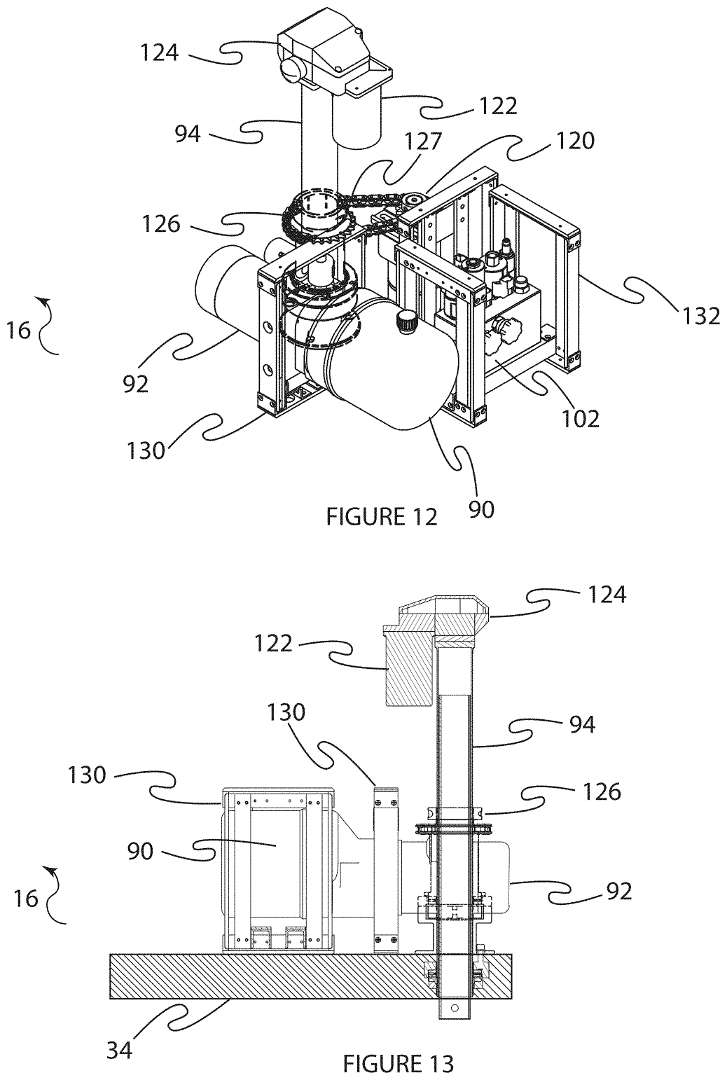

Referring to FIGS. 11 through 13, the upper unit assembly 16 will now be discussed. As shown in FIG. 11, the upper unit assembly 16 includes a hydraulic reservoir 90 fluidly communicated with a hydraulic pump 92, which in turn connected to a jack 94 engaged with a left/right reduction gear 96 mechanically connected with a left/right drive gear 98 through a drive chain 100. The upper unit assembly 16 includes a hydraulic flow control unit 102. The jack 94 includes a jack gear box 124 cooperable with a jack electric motor 122, which in turn mechanically engaged with a bearing unit 126 cooperable with a left/right hydraulic motor 120 connected with one another with a chain 127. The hydraulic reservoir 90 and the hydraulic pump 92 are housed in a first frame 130 connected to a second frame 132 which in turn houses the hydraulic flow control unit 102.

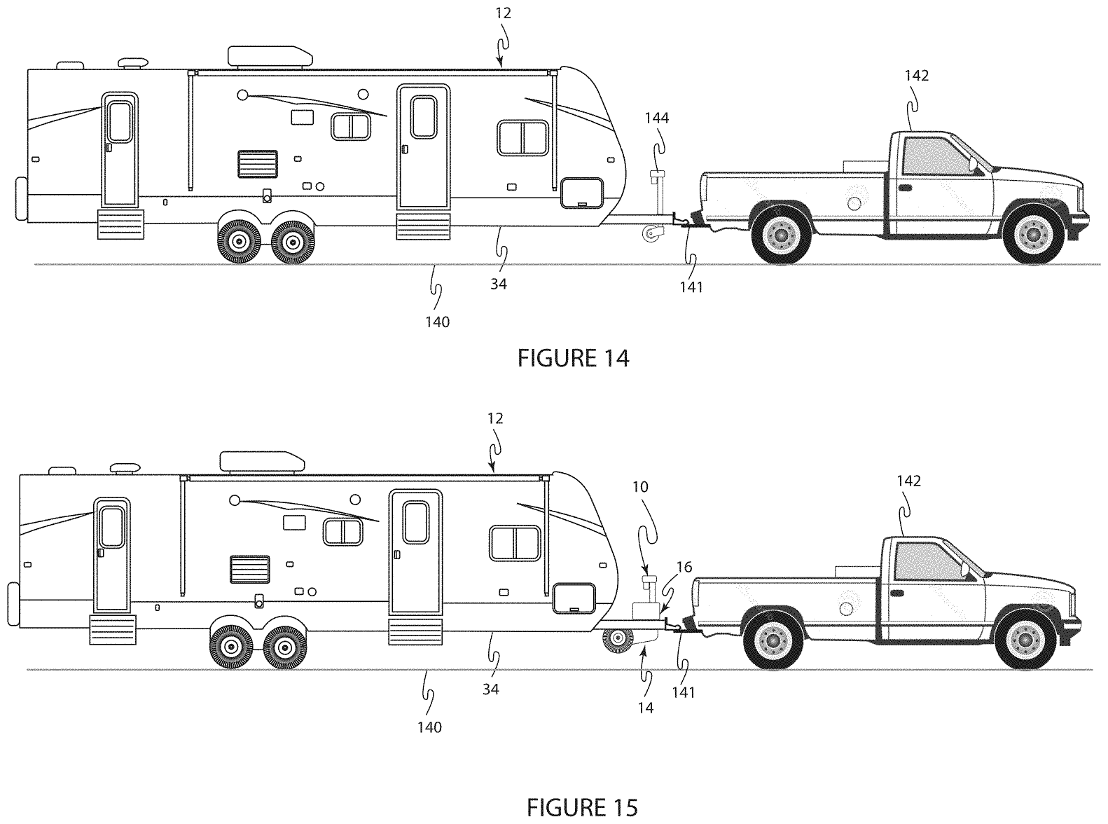

Referring now to FIGS. 14 and 15, FIG. 14 shows a prior art device 144, used only to lower and upper the trailer 12 to level the trailer relative the ground or surface 140 and the vehicle ball 141 of the vehicle 142. FIG. 15 shows the device 10 of the present invention designed to be a permanent part of the trailer 12 and take the place of the existing jack 144 that is mounted on the trailer. This lower unit 14 re-tracks up into the trailer frame 34 allowing for enough clearance between the ground 140 and the bottom of the wheels on the lower unit 143. This allows the trail 12 to be connected to the vehicle 142 and be driven across country to the users destination. Once the driver has reached there destination and the trailer 12 is ready to be parked, the driver will disconnect all attached items which tie the trailer 12 to the vehicle 142.

Alluding to the above, this is done by unlatching release lever for the vehicle ball 141, safety chains and electrical connection at the trailer 12 which tie the vehicle 142 to the trailer 12. The driver will then use the device 10 to take over parking responsibility. First the driver presses the PWR 44 button on the remote 36. Once power has been turned on to the device 10 it is ready to use. Pressing the UP 54 button will lift the trailer 12 hitch off the truck 142 trailer hitch ball 141. Next the trailer 12 must be moved away from the vehicle 142 by pressing the REV 49 button on the remote 36. This will back the trailer 12 away from the vehicle 142. Before driving the trailer 12 to it final destination the device 10 must lower the trailer to a level position. This is done by pressing the DWN 52 button and watching the level usually permanently attach to a trailer 12 for leveling purposes. Once the driver has the trailer level the trailer 12 is now ready to park using the remote controller 36.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A mobility device for moving trailer and maneuvering the trailers between various locations and obstacles, said mobility device comprising;
a lower end assembly;
an upper end assembly;
a control unit included in at least one of said lower end assembly and said upper end assembly;
a remote device wirelessly communicated with said control unit; and
said lower end assembly and said upper end assembly connected along a common axis, wherein said lower end assembly and said upper end assembly are movable relative to one another in vertical direction along said common axis with said lower unit assembly rotatable about said common axis around said upper end assembly to maneuver to move and maneuver the trailers between various locations and obstacles as said remote device send signals to said control unit thereby directing said mobility device to move in different directions.

2. The device as set forth in claim 1, wherein said remote device includes a housing, a touchtone screen, a “power” button, a “move forward” button, a “left turn” button, a “move back” button, a “right turn” button, and “up movement” and “down movement” buttons.

3. The device as set forth in claim 1, wherein said lower unit assembly includes a housing to house forward and reverse drive assembly.

4. The device as set forth in claim 1, wherein said lower unit assembly includes a pair of wheels connected to and extend from said housing, said wheels are rotatable about drive axle defining a wheel axis.

5. The device as set forth in claim 4, including an extender element connected to said housing and is used to adjustably connect said lower unit assembly with said upper unit assembly.

6. The device as set forth in claim 1, including a drive chain tensioner device positioned in said housing along with a hydraulic motor mounting plate.

7. The device as set forth in claim 6, including a drive chain tension knob mechanically connected to the drive chain tensioner device to adjust tension of said drive chain as required and during installation.

8. The device as set forth in claim 7, including a pair of drive wheel axle bearings mechanically connected to said drive wheel axle.

9. The device as set forth in claim 7, wherein said forward/reverse hydraulic motor is mechanically connected to a hydraulic motor intermediate drive gear device, which in turn is connected to a drive wheel intermediate gear device.

10. The device as set forth in claim 7, including a hydraulic motor drive chain engaged about said drive wheel intermediate gear device to translate rotational motion to said drive wheel intermediate gear device.

11. The device as set forth in claim 7, said drive wheel intermediate gear device, through a drive wheel drive chain, translates the rotational motion to a drive wheel drive gear.

12. The device as set forth in claim 7, wherein said drive wheel gear in turn rotates said drive wheel axle in order to move said wheels in forward and reverse directions.

13. The device as set forth in claim 7, wherein said upper unit assembly includes a hydraulic reservoir fluidly communicated with a hydraulic pump, which in turn connected to a jack engaged with a left/right reduction gear 96 mechanically connected with a left/right drive gear 98 through a drive chain 100.

14. The device as set forth in claim 7, wherein said upper unit assembly includes a hydraulic flow control unit.

15. The device as set forth in claim 7, wherein said jack includes a jack gear box cooperable with a jack electric motor, which in turn mechanically engaged with a bearing unit cooperable with a left/right hydraulic motor connected with one another with a chain.

16. The device as set forth in claim 7, wherein said hydraulic reservoir and said hydraulic pump are housed in a first frame connected to a second frame, which in turn houses the hydraulic flow control unit.
